(19) United States
(12) Patent Application Publication
(10) Pub. No.: US 2006/0004875 A1
(43) Pub. Date: Jan. 5, 2006

(54) CMDB schema

(75) Inventors: Anthony L.A. Baron, Woodinville, WA (US); Nigel G. Cain, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/843,024

(22) Filed: May 11, 2004

(51) Int. Cl. G06F 17/30

(52) U.S. Cl. 707/200

(57) ABSTRACT

A schema for use in implementing a configuration management database (CMDB) includes an entity to store information identifying configuration items and a separate entity to store attributes of the configuration items. The CMDB schema may also include a separate entity to track relationships between configuration items. The CMDB schema may also include an entity to store a default list of approvers for changes and/or an entity to store dependencies between requested changes.

### FIELD

Various embodiments described below relate generally to databases and, more particularly but not exclusively to, schemas for configuration management databases.

### BACKGROUND

Configuration management databases (CMDBs) are commonly used to manage the assets (also referred to herein as “configuration items”) of an organization or enterprise. In a typically application, the organization or enterprise has a large number of configuration items (CIs). Because most existing CMDBs are typically designed for a particular type of application (or organization or enterprise), there are, typically, limits to the types of CIs that can be added to these CMDBs or to the types of CI Attributes that may be added to a CI already supported in these CMDBs. Further, because they are designed for a particular type of application or organization or enterprise, these existing CMDBs generally lack flexibility in implementing procedures or processes for managing changes to CIs.

### SUMMARY

In accordance with aspects of the various described embodiments, a flexible schema for CMDBs is provided. In one aspect, a CMDB schema includes a separate table to record configuration item (CI) attributes. In one embodiment according to this aspect, the separate CI Attribute table allows a CMDB to support any arbitrary type of CI.

In another aspect, a CMDB schema includes a separate table to track relationships between CIs. In one embodiment according to this aspect, the separate CI relationship table allows a CMDB to support complex relationships between CIs.

In still another aspect, a CMDB schema includes a default list of approvers for changes and dependencies between requested changes. In one embodiment according to this aspect, this aspect allows a CMDB to support flexible change management procedures that can be adapted to for different organizations.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating CIs in an enterprise or organization, according to one embodiment.

FIG. 2 is a block diagram illustrating a CMDB system, according to one embodiment.

FIGS. 3 and 3A are flow diagrams illustrating operational flow in implementing parts of the CMDB and associated change management of the system of FIG. 2, according to one embodiment.

FIG. 4 is an entity-relationship (ER) diagram illustrating a schema for defining CIs in a CMDB, according to one embodiment.

FIG. 5 is an ER diagram illustrating a schema for managing changes in CIs in a CMDB, according to one embodiment.

FIG. 6 is an ER diagram illustrating a complete CMDB schema, according to one embodiment.

FIG. 7 is a block diagram illustrating an example computing environment suitable for practicing the above embodiments.

### DETAILED DESCRIPTION

Various embodiments are directed to a schema and system to implement CMDBs that can be adapted for a wide variety of organizations or enterprises. Some of these embodiments include a separate CI Attribute table that can be used to support any arbitrary type of CI. Other embodiments include a separate CI relationship table that can allow the CMDB to support complex relationships between CIs. Still other embodiments include a separate a default list of approvers for changes and dependencies between requested changes that can be used to support flexible change management procedures in a CMDB to support different organizations or enterprises. Several embodiments are described below.

### Example Organization and CIs

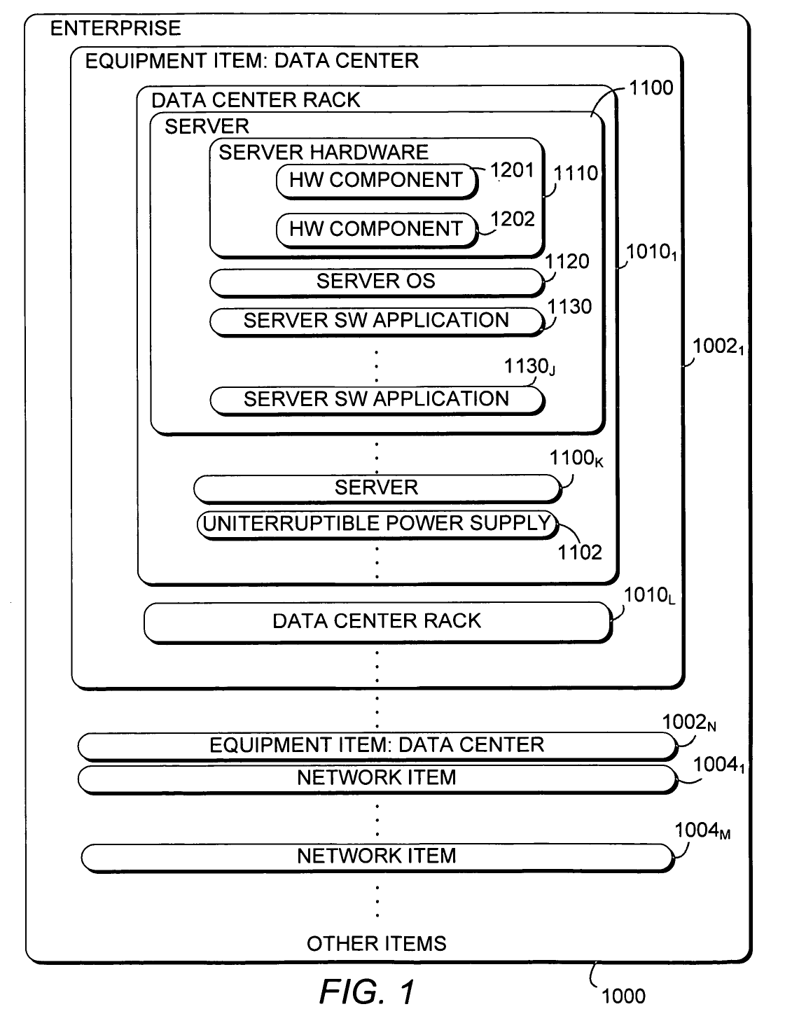

FIG. 1 schematically illustrates CIs in an organization or enterprise 1000, according to one embodiment. In some enterprises or organizations, the number of CIs that the enterprise wants to manage may be extremely large and complex. As will be described below, FIG. 1 illustrates just how complex the CI management problem can become for even a limited part of an enterprise; e.g., the part of the enterprise consisting of a few data centers that are accessible via a few networks.

In this example, enterprise 1000 includes several CIs such as: (a) equipment items that include a data center 1002₁, a data center 1002₂, . . . , and a data center 1002_{N}; (b) network items such as a network 1004₁, a network 1004₂, . . . and a network 1004_{M}; and other items that are not shown to avoid obscuring the figure. These other CIs can include, for example, work stations, personal computers, or other appliances or devices (e.g., cameras, camcorders, personal digital assistants, cellular telephones, etc.) that can be connected to the network items to access data stored in the data centers. In general, CIs can include any item that the organization would like to manage/control, including intangible items (e.g., end user license agreements, patents, trademarks, etc.) as well as the hardware and software items illustrated in FIG. 1.

Further, each of these equipment and network CIs may be made up of additional CIs. For example, data center 1002₁ in this embodiment includes a data center rack 1010₁, a data center rack 1010₂, . . . , and a data center rack 1010_{L}. Data centers can also include other CIs that are not shown in FIG. 1, depending on the degree or level of subcomponents of the data centers that the organization or enterprise wants to manage.

Similarly, in this example embodiment, data center rack 1010₁ includes a server 1100₁, a server 1100₂, . . . , and a server 1100_{K}; and an uninterruptible power supply (UPS) 1102. Data center racks can also include other CIs that are not shown in FIG. 1, depending on the degree or level of subcomponents of the data center racks that the user wants to manage.

The servers can be made up of CIs as well. For example, server 1100₁ includes: a server hardware item 1110; a server operating system (OS) 1120; a server software application 1130₁, a server software application 1130₂, . . . , and a server software application 1130_{J}. In this example, server hardware item 1110 includes hardware components 1201 and 1202 (e.g., a hard drive and a random access memory). Servers can also include other CIs that are not shown in FIG. 1, depending on the degree or level of subcomponents of the servers that the user wants to manage.

In addition to the hierarchical relationship between CIs and other CIs that serve as their subunits, further complexity is added to the CI management problem by other relationships between CIs. For example, a network CI has a relationship with all of the workstations that may be connected to that network CI. Thus, changing that network CI can have an effect on all of the workstations that are connected to that network CI.

Further, still more complexity is added to the CI management problem by requiring the CMDB to be flexible enough to support new types of CIs that are needed, for example, as new needs arise for the enterprise, or become available as new technology emerges or is invented.

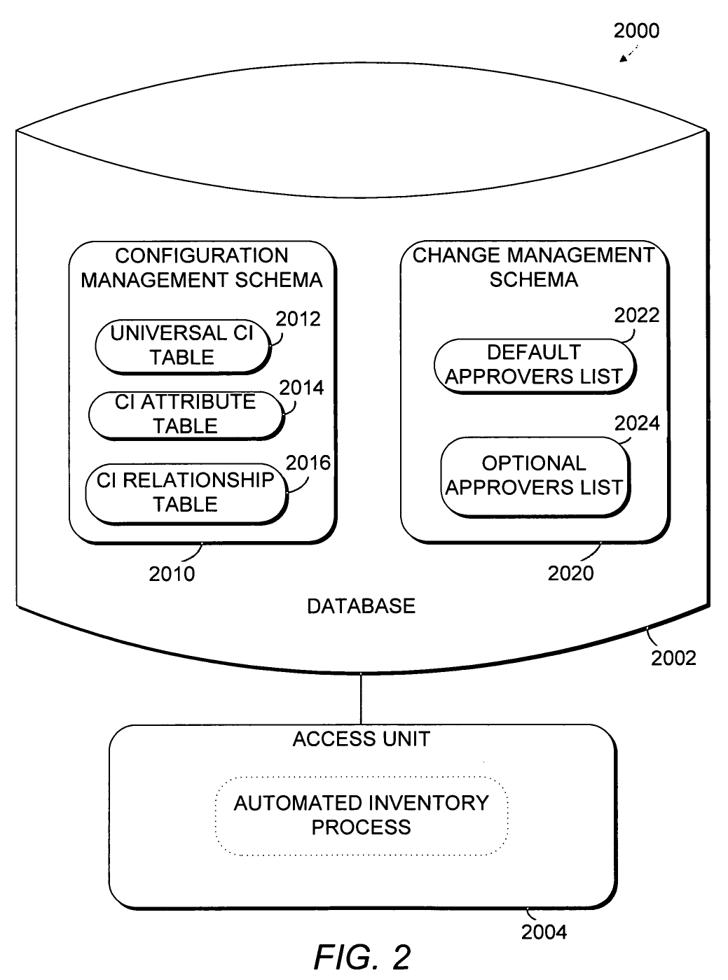

One embodiment of a CMDB that can efficiently support the aforementioned complex CI management problems is described below in conjunction with FIG. 2.

### Overview of Example CMDB System

FIG. 2 illustrates a CMDB system 2000 according to one embodiment. In this embodiment, CMDB system 2000 includes a database 2002 and an access unit 2004 that can be used to read, write and change configuration management data stored in database 2002. Configuration management data, in this embodiment, is organized according to: (1) a configuration management schema 2010 that defines tables that include a CI table 2012, a separate CI Attribute table 2014 and a separate CI relationship table 2016; and (2) a change management schema 2020 that defines a default approvers list 2022 and an optional approvers lists 2024. These schemas typically include other standard tables used in CMDBs but are omitted here to promote clarity. In other embodiments, these tables and lists can be replaced with objects.

In this embodiment, CI table 2012 is used to store CIs that have been defined for the organization or enterprise. As will be described below, in some embodiments, CI table 2012 can be used to support any arbitrary type of CI, including CI types that are currently unknown but may emerge in the future.

CI Attribute table 2014 is used to store attributes of CIs. In one embodiment, CI Attribute table 2014 includes a column corresponding to each CI of CI table 2012, by which each CI's attributes can be accessed. Because CI Attribute table 2014 is separate from CI table 2012 in this embodiment, any CI type can be supported by CI table 2012. Although the CI Attribute table stores the CI Attribute separately from the CI table, the CI table has at least one attribute that serves as an identifier for the CI. In some embodiments, the CI identifier attribute is repeated in the CI Attribute table (e.g., as a foreign key in relational database embodiments).

CI relationship table 2016 is used to record relationships between CIs. In one embodiment, CI relationship table 2016 includes an entity or row that corresponds to a relationship between a pair of CIs of CI table 2012. The relationships associated with a particular CI can then be accessed via a query using that CI. Because CI relationship table 2016 is separate from CI table 2012 in this embodiment, any CI type of relationship can be supported by the CMDB.

### Example Operational Flows in Implementing Portions of a CMDB

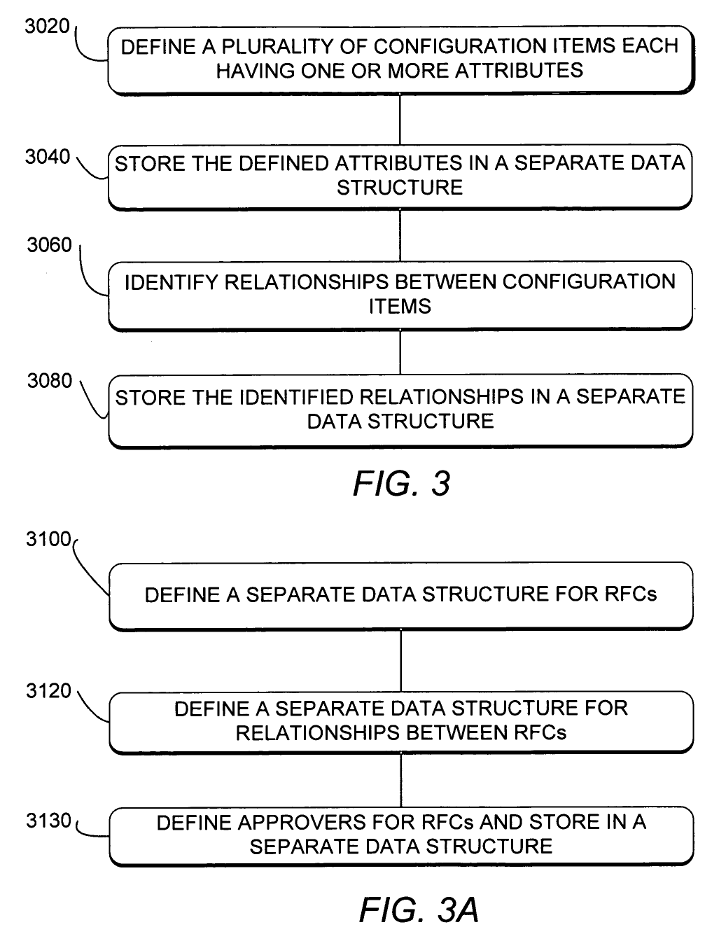

FIG. 3 illustrates operational flow in implementing a part of a CMDB. For example, the operational flow of FIG. 3 can be used to implement a part of CMDB 2002 (FIG. 2) according to configuration schema 2010 (FIG. 2), according to one embodiment. In one embodiment, the implementer or installer installs the CMDB by implementing tables to form a relational database using suitable standard techniques. The tables can then be accessed and updated using any suitable standard technique (e.g., using a known transaction processor or manager). In accordance with one embodiment, the installer or implementer would implement configuration management data structures for a part of CMDB as described below.

In a block 3020, the implementer identifies and defines the CIs that the organization or enterprise would like to manage. For example, an organization may have items such as those illustrated in FIG. 1, but may not want to manage CIs down to the level of hardware components 1201 and 1202. As previously described, the organization can define hardware, software, networks, communication links, intangible items, etc. as CIs. This embodiment provides the implementer the flexibility to define CIs as desired and to define them to a desired level. In addition to identifying the CIs, the implementer also identifies and defines at least one CI Attribute for each CI.

In a block 3040, the implementer stores the CI Attribute(s) that were defined in block 3020 in a data structure that is separate from that storing the CIs that were identified in block 3020. For example, in a relational database embodiment, the implementer defines and forms a CI table and a separate related CI Attribute table to store CIs and CI Attributes, respectively. New CIs and new CI Attributes can be added to the appropriate data structure by the implementer or by an administrator for the CMDB. Because the CI table and the CI Attribute tables are separate, the CI table can be used to support any arbitrary type of CI, including CI types that are currently unknown but may emerge in the future. In contrast, if the CI Attributes were part of the CI table, adding a newly created CI may be difficult because the existing CI Attributes may not adequately support the new CI.

In a block 3060, the implementer identifies relationships, if any, between the CIs defined in block 3020. In this context, the term “relationship” is not used to refer to relationships between entities in an entity-relationship (ER) model, but rather refers to relationships between CIs. For example, a server CI can be related to a network CI, which can be related to a workstation CI that is attached to that network CI, and so on. This embodiment provides the implementer the flexibility to define relationships between CIs as desired.

In a block 3080, the implementer stores the relationships identified in block 3060 in a separate data structure. For example, continuing the relational database example described in conjunction with block 3040, the implementer defines and forms a separate related CI relationship table to store the identified relationships. In one embodiment, the CI relationship table stores identifiers for the CIs in the relationship so that the CI relationship table can be queried for all of the defined relationships involving a selected CI. Because the CI table and the CI relationship tables are separate, the CI relationship table can be used to support any arbitrary type of relationship and multiple relationships for each CI, including relationships that are currently unknown but may emerge in the future.

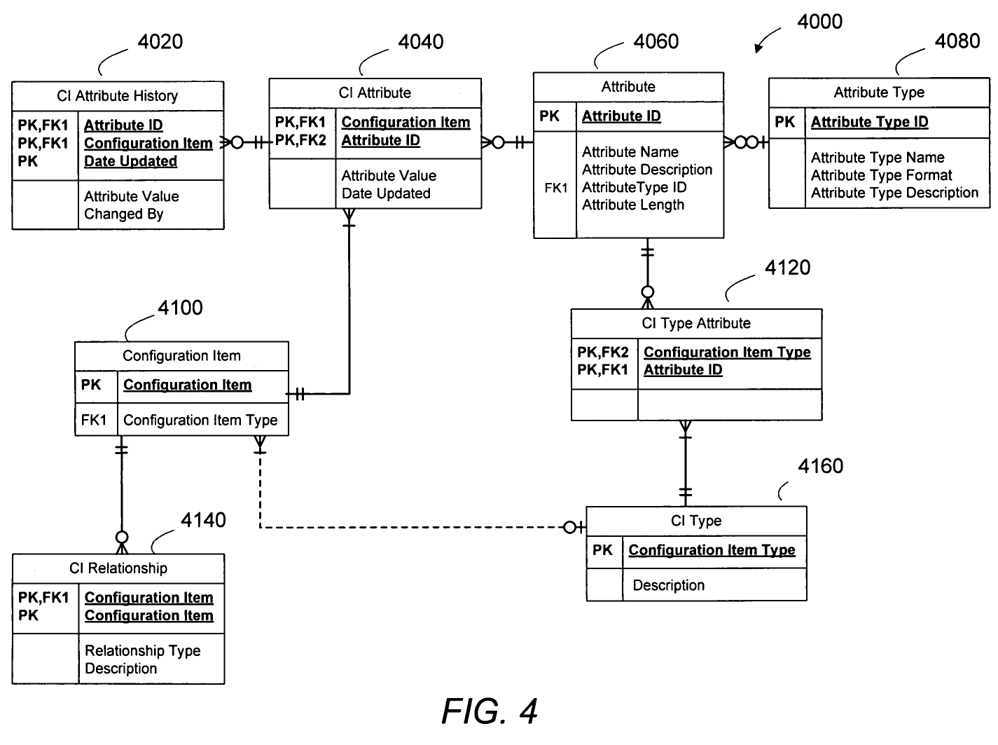

Although the operations are described above as being performed sequentially in the order shown in FIG. 3, in other embodiments some operation(s) may be performed in different orders or in parallel. Further, although not described, other operations are performed in implementing or installing the CMDB. For example, in a relational database embodiment, other tables can be formed in addition to the CI, CI Attribute and CI relationship tables described. Additional tables to implement a system for defining CIs in a CMDB according to one embodiment are described below in conjunction with FIG. 4.

FIG. 3A illustrates operational flow in implementing another part of a CMDB. For example, the operational flow of FIG. 3A can be used to implement a part of CMDB 2002 (FIG. 2) having change management schema 2020, according to one embodiment. As mentioned above in conjunction with FIG. 3, in one embodiment, the implementer or installer installs the CMDB by implementing tables to form a relational database using suitable standard techniques. The tables can then be accessed and updated using any suitable standard technique (e.g., using a known transaction processor or manager). In one embodiment, the tables can be updated according to change management schema 2010. In accordance with this embodiment, the installer or implementer would implement change management data structures for a CMDB, as described below.

In a block 3100, the implementer defines and forms a request for change (RFC) data structure to store RFCs. Continuing the relational database example described above in conjunction with FIG. 3, in one embodiment the implementer defines and forms a RFC table to store RFCs. In this example embodiment, each RFC would include have an associated identifier or number, a description of the requested change, and one or more “fields” or attributes defining how the RFC is to be approved. Other information related to the RFC can be stored in other attributes or fields of the RFC data structure. In some embodiments, RFCs can be generated by users as well as CMDB administrators and/or implementers.

In a block 3120, the implementer defines and forms a RFC relationships data structure to store relationships between RFCs. For example, in some scenarios, in order for a new RFC to be approved, one or more other RFCs may need to be approved concurrently or prior to the new RFC. For example, an RFC to replace a faulty parallel port printer with a universal serial bus (USB) printer for a workstation may require prior approval an RFC to install a USB card in that workstation.

In one relational database embodiment, the implementer defines and forms a separate RFC relationships table to store such relationships between RFCs. In one embodiment, the RFC relationship table stores identifiers for the related RFCs so that the RFC relationship table can be queried for all of the defined relationships involving a selected RFC. Because the RFC table and the RFC relationship tables are separate, the RFC relationship table can be used to support any arbitrary type of relationship and multiple relationships for each RFC, including relationships that are currently unknown but may emerge in the future.

In a block 3130, the implementer defines and forms a default approvers data structure to store identifiers of people authorized to approve RFCs. In one relational database embodiment, the implementer identifies the authorized people and defines and forms a separate default approvers list table to store identifiers of these identified approvers. An example scenario in processing a RFC is described below.

In response to a RFC, for example, an administrator of the CMDB can store information related to the RFC in the RFC data structure as defined in block 3100. In addition, the administrator can store information related to relationships (if any) with other previously entered RFCs in the RFC relationships data structure. The administrator can then consult the RFC relationships data structure to determine if the related RFCs (if any) have been approved. If there are no denied RFCs “blocking” the current RFC, the administrator can then consult the default approvers list data structure to determine the person or persons to be contacted to approve the RFC. The administrator can provide information about relationships with other RFCs to the person(s) to aid the approval decision. Further, in some embodiments, the administrator can also provide information about relationships between CIs that are affected by the RFC.

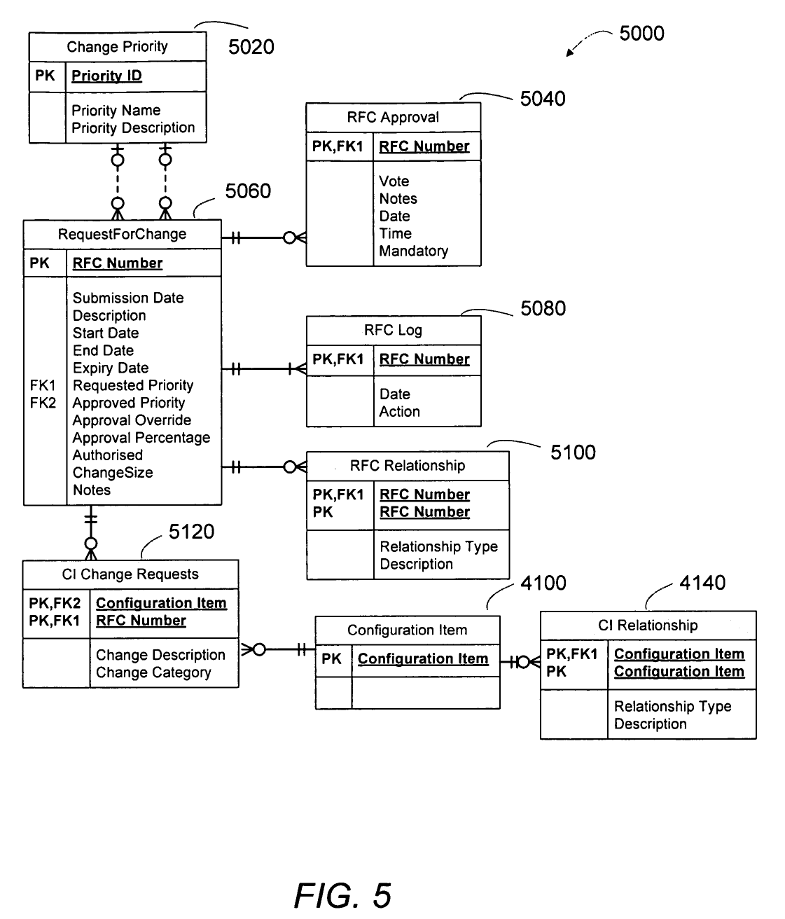

Although the operations are described above as being performed sequentially in the order shown in FIG. 3A, in other embodiments some operation(s) may be performed in different orders or in parallel. Further, although not described, other operations are performed in implementing or installing the change management portion of the CMDB. For example, in a relational database embodiment, other tables can be formed in addition to the RFC, default approvers list and RFC relationship tables described. Additional tables to implement a CMDB change management system according to one embodiment can be implemented according to the schema described below in conjunction with FIG. 5.

### Example CMDB Schemas

FIG. 4 is an entity-relationship (ER) diagram illustrating a schema 4000 for defining CIs in a CMDB, according to one embodiment. In this embodiment, schema 4000 includes a CI Attribute History entity 4020, a CI Attribute entity 4040, an Attribute entity 4060, an Attribute Type entity 4080, a CI entity 4100, a CI Type Attribute entity 4120, a CI Relationship entity 4140 and a CI Type entity 4160. These entities are described further below.

Although the ER diagram of FIG. 4 defines the attributes of each entity and the relationship between other entities, these entities are described below according to one embodiment for completeness.

In this embodiment, CI Attribute History entity 4020 is used to store update information about a CI Attribute and has a composite primary key consisting of a CI Attribute identifier denoted as “Attribute ID”, a CI identifier denoted as “Configuration Item”, and a date when the CI Attribute was updated denoted “Date Updated”. The “Configuration Item” and “Attribute ID” attributes are foreign keys respectively originating in CI entity 4100 and Attribute entity 4060 for a particular CI. In this embodiment, CI Attribute History entity 4020 also has attributes for storing the value of the CI Attribute denoted “Attribute Value” and for identifying the person that changed the CI Attribute denoted “Changed By”.

CI Attribute entity 4040 is used to store information about CI Attributes and has a composite primary key consisting of the aforementioned “Attribute ID” and “CI identifier” attributes. In addition, CI Attribute entity 4040 has the aforementioned “Attribute Value” and an attribute storing the date the CI Attribute was updated denoted “Date Updated”.

Attribute entity 4060 is used to store information about attributes defined in CI Attribute entity 4040. In this embodiment, Attribute entity 4060 has a primary key consisting of the aforementioned “Attribute ID” attribute. Attribute entity 4060 has attributes for storing:

(a) the name for the CI Attribute denoted “Attribute Name;

(b) a description of the CI Attribute denoted “Attribute Description”;

(c) a length of the CI Attribute denoted “Attribute Length”; and

(d) an identifier for the CI Attributes Type denoted “Attribute Type ID”, which is a foreign key originating in Attribute Type entity 4080 (described in more detail below).

Attribute Type entity 4080 is used to store information defining attribute types. In this embodiment, Attribute Type entity 4080 has a primary key consisting of the “Attribute Type ID” attribute mentioned above in conjunction with Attribute entity 4060. Attribute Type entity 4080, in this embodiment, also has attributes for storing:

(a) the name for the Attribute Type denoted “Attribute Type Name”;

(b) the format of the Attribute Type denoted “Attribute Type Format”; and

(c) a description of the Attribute Type denoted “Attribute Type Description).

CI entity 4100 is used to store information about CIs being managed in the organization. In this embodiment, CI entity 4100 has a primary key consisting of the “Configuration Item” attribute described above for CI Attribute History entity 4020. CI entity 4100, in this embodiment, also has an attribute for storing a type of the CI denoted “Configuration Item Type”. The “Configuration Item Type” attribute is also a foreign key originating in CI Type entity 4160 described in more detail below.

CI Type Attribute entity 4120 is used to store information about types of CI attributes being managed in the organization. In this embodiment, CI Type Attribute entity 4120 has a primary key consisting of:

(a) the “Configuration Item Type” attribute described above for CI entity 4100; and

(b) the “Attribute ID” attribute described above for CI Attribute History ID entity 4020. The “Configuration Item Type” and “Attribute ID” attributes are also foreign keys originating in CI type entity 4160 and Attribute entity 4060, respectively.

CI Relationship entity 4140 is used in this embodiment to store information abut relationships between pairs of CIs. CI Relationship entity 4140 has a composite primary key (which also serves as foreign key in this embodiment) consisting of the aforementioned “Configuration Item” attribute of the related CI and a “Configuration Item” attribute of another instance of a CI. CI Relationship entity 4140 also has an attribute for storing information related to the type of relationship denoted “Relationship Type” and another attribute for storing a description of the relationship, denoted “Description”.

CI Type entity 4160 is used to store information about types of CIs being managed in the organization. In this embodiment, CI type entity 4160 has a primary key consisting of an identifier for the CI type, which is denoted “Configuration Item Type” in this embodiment. In addition, this embodiment of CI Type entity 4160 includes an attribute for storing a description of the type of CI, denoted “Description”.

The relationships between the above entities for one embodiment are described below.

In CI entity 4100, each instance of a CI must have at least one CI attribute defined in CI Attribute entity 4040, while each instance of a CI Attribute is related to only one CI of CI entity 4100. Further, each instance of a CI of CI entity 4100 may have one or more relationships with other CIs defined in CI Relationship entity 4140, while each instance of a CI relationship in CI relationship entity 4140 has only one CI defined in CI entity 4100. In addition, in this embodiment, each instance of a CI of CI entity 4100 may optionally have a weak or non-identifying relationship with a CI type defined in CI Type entity 4160, while each instance of a CI type in CI Type entity 4160 is weakly related to a CI of CI entity 4100.

In CI Attribute entity 4040, each instance of a CI Attribute may have one or more updates recorded in CI Attribute History entity 4020, while each instance of an update of CI Attribute History 4020 is related to only one CI Attribute of CI Attribute entity 4040. Further, each instance of a CI Attribute of CI Attribute entity 4040 has only one Attribute of Attribute entity 4060.

In Attribute entity 4060, each instance of an Attribute may have an Attribute Type defined in Attribute Type entity 4080, while each instance of an Attribute Type may be related to one or more Attributes of Attribute entity 4060. Further, each instance of an Attribute of Attribute entity 4060 may have one or more CI Type Attributes defined in CI Type Attribute entity 4120, while each instance of a CI Type Attribute has only one Attribute of Attribute entity 4060.

In CI Type Attribute entity 4120, each instance of a CI Type Attribute is related to only one CI Type of CI Type entity 4160, while each instance of a CI Type has one or more CI Type Attributes defined in CI Type Attribute entity 4120.

Schema 4000 can be used by one of ordinary skill in the art of databases to implement a CI definition portion of a CMDB using any suitable technique. For example, by forming a table for each entity of schema 4000 (in which each instance of the entity serves as a row of the table and the entities attributes serve as columns of the table), a relational database embodiment of the CI definition portion of a CMDB can be implemented.

FIG. 5 is an ER diagram illustrating a schema 5000 for managing changes in CIs in a CMDB, according to one embodiment. In this embodiment, schema 5000 includes a Change Priority entity 5020, a RFC Approval entity 5040, a RFC entity 5060, a RFC log entity 5080, a RFC Relationship entity 5100, and a CI Change Requests entity 5120. These entities are described further below.

Although the ER diagram of FIG. 5 defines the attributes of each entity and the relationship between other entities, these entities are described below according to one embodiment for completeness.

In this embodiment, Change Priority entity 5020 is used to store priority information about a RFC and has a primary key consisting of an identifier for the Priority denoted “Priority ID”. In addition, Change Priority entity 5020 includes attributes denoted “Priority Name” and “Priority Description” to store the name and description of the Change Priority.

RFC Approval entity 5040 is used to store information regarding the approval/disapproval of RFCs. In this embodiment, RFC Approval entity 5040 has a primary key (which also serves as a foreign key) consisting of a “RFC Number” attribute, which is a defined in RFC entity 5060. RFC Approval entity 5040 also has attributes for storing:

(a) the result of the voting denoted “Vote”;

(b) information about the voting denoted “Notes”;

(c) the date the voting took place denoted “Date”;

(d) the time the voting took place denoted “Time”; and

(e) person(s) whose vote(s) are mandatory to approve the related RFC denoted “Mandatory”. In other embodiments that include a default approvers list (described previously), RFC Approval entity 5040 can include other attributes that are related (either directly or indirectly) to the default approvers list

RFC entity 5060 is used to store information regarding RFCs submitted by users, administrator(s), etc. In this embodiment, RFC entity 5060 has a primary key consisting of an identifier for the RFC denoted “RFC Number”. In one embodiment, the RFC Number is generated by incrementing the RFC Number for the previously submitted RFC or assigning a unique number. RFC entity 5060 also has attributes for storing:

(a) the date the RFC was submitted denoted “Submission Date”;

(b) information about the RFC denoted “Description”;

(c) the date the change (if approved) is to start denoted “Start Date”;

(d) the date the change (if approved) is to be completed denoted “End Date”;

(e) the date at which the RFC expires denoted “Expiry Date”;

(f) the priority requested by the submitter denoted “Requested Priority”, which also serves as a foreign key for the Priority ID entity in this embodiment;

(g) the priority granted by the approver(s), denoted “Approved Priority”, which also serves as a foreign key for the Priority ID entity in this embodiment

(h) whether an approval has been overridden (i.e., the RFC is later denied despite being approved) denoted “Approval Override”;

(i) the percentage of approvers that approved the RFC denoted “Approval Percentage”;

(j) whether the RFC is approved denoted “Authorized”;

(k) the complexity of the change denoted “ChangeSize”; and

(l) additional information about the RFC denoted “Notes”.

RFC Log entity 5080 is used to store information about RFCs that were handled by the CMDB's change management system. In this embodiment, RFC Log entity 5080 has a primary key (which also serves as a foreign key) consisting of the aforementioned “RFC Number” attribute defined in RFC entity 5060. RFC Log entity 5080 also has “Date” and “Action” attributes for storing the date and status of the latest activity regarding the RFC.

RFC Relationship entity 5100 is used to store information regarding relationships between RFCs. RFC Relationship entity 5100, in this embodiment, has a composite primary key (and also serves as foreign key) consisting of the aforementioned “RFC Number” attribute defined in RFC entity 5060 for the present RFC, and a “RFC Number” attribute of another instance of a RFC. CI Relationship entity 4140 also has an attribute for storing information related to the type of relationship denoted “Relationship Type” and another attribute for storing a description of the relationship, denoted “Description”.

CI Change Requests entity 5120 is used to store additional information about RFCs that request changes to CIs. In this embodiment, CI Change Requests entity 5120 has a composite primary key consisting of the aforementioned “Configuration Item” attribute (see CI entity 4100 of FIG. 4) and the aforementioned “RFC Number” attribute. In addition, the “Configuration Item” and “RFC Number” attributes are also foreign keys defined in RFC entity 5060 and CI entity 4100. Further, CI Change Requests entity 5120 also includes “Change Description” and “Change Category” attributes to store information describing the change and the category of the change.

The relationships between the above entities shown in FIG. 5 are described below for one embodiment.

In RFC entity 4060, each instance of a RFC may have a non-identifying priority stored in Change Priority entity 5020, while each instance of a priority of Change Priority entity 5020 may be weakly related to one or more RFCs of RFC entity 4060. In this embodiment there are two links to the Change Priority entity 5020, with one link representing the change indicated by the change initiator and the other link assigned by the change manager. In addition, each instance of a RFC may have one or more approvals stored in RFC Approval entity 5040, while each instance of an approval is related to only one RFC of RFC entity 5060. Further, each instance of a RFC has one or more log entries stored in RFC Log entity 5080, while each instance of a log entry is related to only one RFC of RFC entity 5060. Still further, each instance of a RFC may have one or more RFC relationships defined in RFC Relationship entity 5100, while each instance of a RFC relationship is associated with only one RFC of RFC entity 5060. Each instance of an RFC in RFC entity 5060 may also include a CI change request stored in CI Change Requests entity 5120, while each CI change request is related to only one RFC of RFC entity 5060.

In CI Change Requests entity 5120, each instance of a CI change request is related to only one CI of CI entity 4100, while each instance of a CI in CI entity 4100 may be related to one or more CI change requests stored in CI Change Requests entity 5120.

Schema 5000 can be used by one of ordinary skill in the art of databases to implement a part of a CMDB using any suitable technique, as described previously for schema 4000 (FIG. 4).

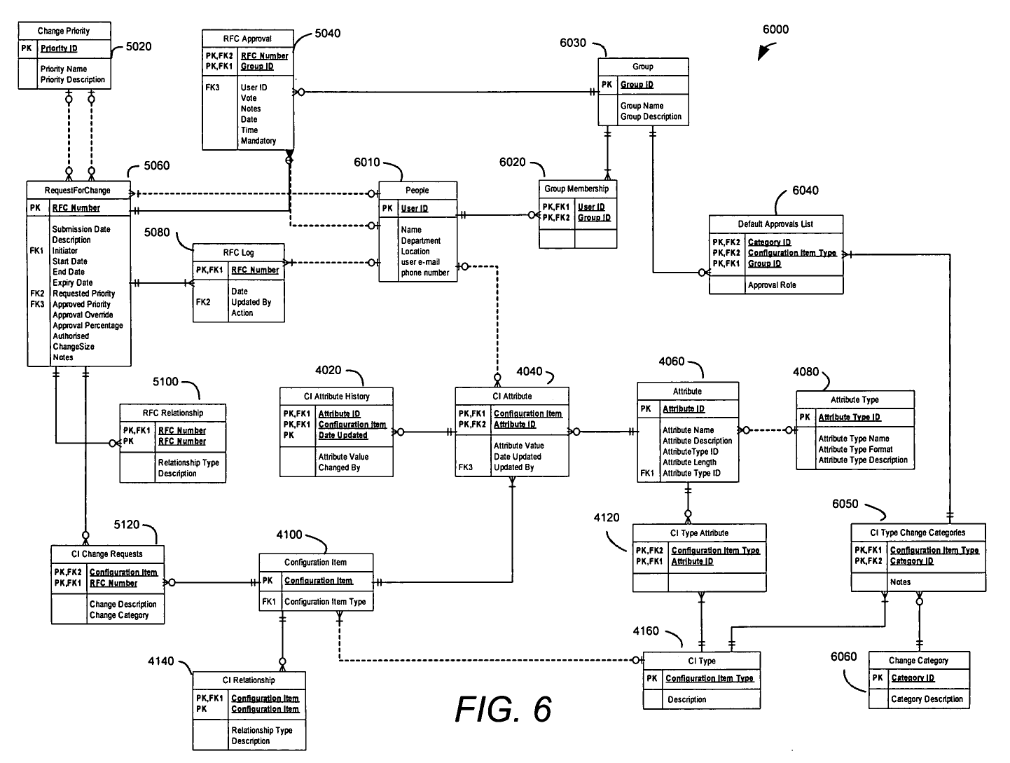

FIG. 6 is an ER diagram illustrating a complete CMDB schema 6000, according to one embodiment. In this embodiment, schema 6000 includes all of the entities described above in conjunction with FIGS. 4 and 5 and, in addition, includes a People entity 6010, a Group Membership entity 6020, a Group entity 6030, a Default Approvals List entity 6040, a CI Type Change Categories entity 6050, and a Change Category 6060. These entities are described further below.

Although the ER diagram of FIG. 6 defines the attributes of each entity and the relationship between other entities, the entities not previously described in conjunction with FIGS. 4 and 5 are described below according to one embodiment for completeness.

In this embodiment, People entity 6010 is used to store information about people in the organization that potentially may be approvers and/or submitters of RFCs. People entity 6010 has a primary key consisting of an identifier for a person denoted “User ID”. In addition, People entity 6010 includes attributes denoted “Name”, “Department”, “Location”, “user e-mail” and “phone number” to store the name and other contact information of the person.

Group Membership entity 6020 is used to store information about a group's membership. In this embodiment, Group Membership entity 6020 has a primary key consisting of the aforementioned “User ID” attribute and a “Group ID” attribute. These attributes are also foreign keys defined in People entity 6010 and Group entity 6030, respectively.

Group entity 6030 is used to define groups of people in the organization that have common features such as, for example, functions (e.g., approval authorization). In this embodiment, Group entity 6030 has a primary consisting of the “Group ID” attribute, which is used as an identifier for an instance of a group. In addition, Group entity 6030 also includes “Group Name” and “Group Description” attributes to store name and description information about the group.

Default Approvals List entity 6040 is used to store a list of people authorized to approve RFCs. In this embodiment, Default Approvals List 6040 has a composite primary key consisting of a “Category ID” attribute, a “Configuration Item Type” attribute, and the “Group ID” attribute. The “Category ID” attribute, “Configuration Item Type” attribute, and “Group ID” attribute are also foreign keys defined in the Change Category entity 6060 (defined in more detail below), CI Type entity 4160, and Group entity 6030, respectively. In addition, Default Approvals List entity 6040 also has an “Approval Role” attribute to define the role the people on this list play in approving a RFC. For example, the role may be to override an approval, or to bypass the standard approval process in emergency situations

CI Type Change Categories entity 6050 is used to store information about categories of CI Type changes. In this embodiment, CI Type Change Categories entity 6050 has a composite primary key consisting of the aforementioned “Configuration Item Type” and “Category ID” attributes. The “Configuration Item Type” and “Category ID” attributes are also foreign keys defined in CI Type entity 4160 and Change Category entity 6060 (described in more detail below), respectively. CI Type Change Categories entity 6050 also has a “Notes” attribute to store information about the category.

Change Category 6060 is used to store information regarding categories of changes. In this embodiment, Change Category 6060 has a primary key consisting of the “Category ID” attribute, which is used to identify the change category. Typically, the CMDB implementer predefines the change categories. Change Category 6060 also has a “Category Description” attribute to store a description of the category.

Further, in the embodiment of FIG. 6, some of the entities include additional attributes related to persons included in People entity 6010. For example, compared to the embodiment of FIG. 5, RFC entity 5060 in the embodiment of FIG. 6 has an additional attribute denoted “Initiator” to store information about the person (described in People entity 6010) who submitted the RFC. In this embodiment, the “Initiator” attribute is a foreign key defined in the People entity 6010. RFC Approval entity 5040 includes a “User ID” attribute that is a foreign key defined in People Entity 6010. RFC Log entity 5080 includes an “Updated By” attribute which is a foreign key defined in People entity 6010. These examples show how the entities of the above-described schemas are extensible.

The relationships between the above entities shown in FIG. 6 are described below for one embodiment. The relationships between entities previously described in conjunction with FIGS. 4 and 5 are omitted to avoid redundancy.

In People entity 6010, each instance of a person may be a member of one or more groups stored in Group Membership entity 6020, while each instance of a member of Group Membership entity 6020 is related to only one person of People entity 6010. Further, each instance of a person may be weakly related to one or more instances of CI Attribute entity 4040, while each instance of CI Attribute entity 4040 may be weakly related to a person of People entity 6010. Still further, each instance of People entity 6010 is weakly related to one or more log entries of RFC Log entity 5080, while each instance of a log entry may be weakly related to person of People entity 5080. In addition, each instance of People entity 6010 is weakly related to one or more RFCs of RFC entity 5060, while each instance of a RFC may be weakly related to a person of People entity 6010. Also, each instance of People entity 6010 is weakly related to one or more instances of RFC Approval entity 5040, while each instance of RFC Approval entity 5040 may be weakly related to a person of People entity 6010.

In Group entity 6030, each instance of a group is related to one or more instances of Group Membership entity 6020, while each instance of Group Membership entity 6020 is related to only one group of Group entity 6030. Further, each instance of Group entity 6030 may be related to one or more instances of RFC Approval entity 5040, while each instance of RFC Approval entity 5040 is related to only one instance of Group entity 6030. Still further, each instance of Group entity 6030 may be related to one or more instances of Default Approvals List entity 6040, while each instance of Default Approvals List entity 6040 is related to only one group of Group entity 6030.

In Default Approvals List entity 6040, each instance is related to only instance of CI Type Change Categories entity 6050, while each instance of CI Type Change Categories entity 6050 is related to one or more instances of Default Approvals List entity 6040.

In CI Type Change Categories entity 6050, each instance is related to only one instance of Change Category entity 6060, while each instance of Change Category entity 6060 may be related to one or more instances of CI Type Change Categories entity 6050. Further, in this embodiment, each instance of CI Type Change Categories entity 6050 is related to only one instance of CI Type entity 4160, while each instance of CI Type entity 4160 is related to one or more instances of CI Type Change Categories entity 6050.

Schema 6000 can be used by one of ordinary skill in the art of databases to implement a CMDB using any suitable technique, as described previously for schema 4000 (FIG. 4).

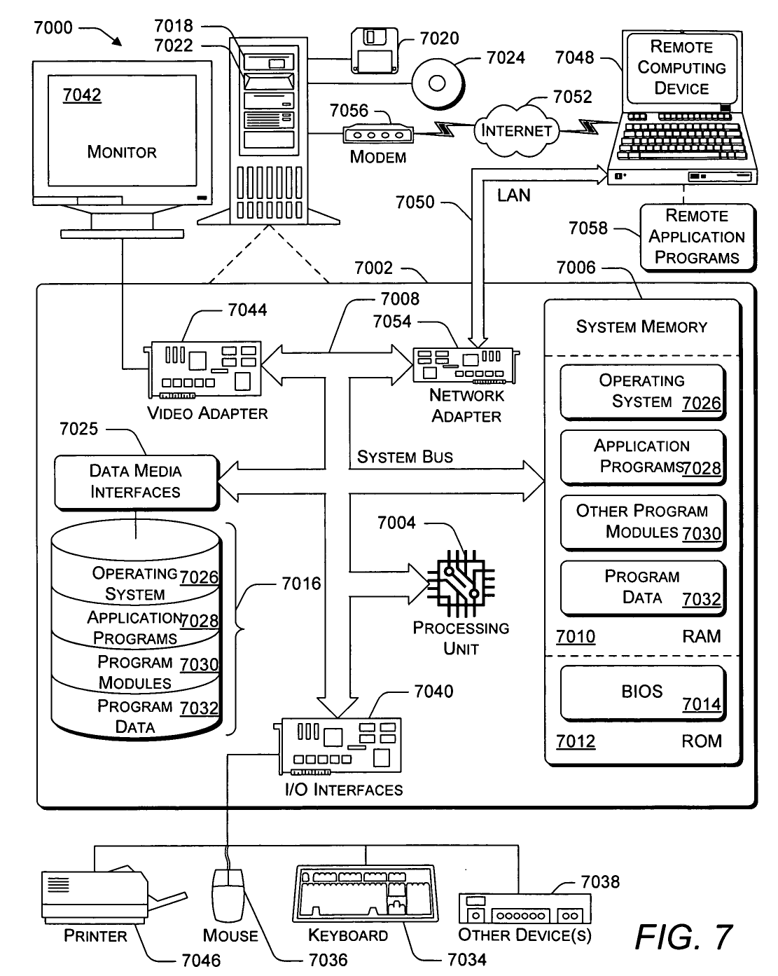

FIG. 7 illustrates a general computer environment 7000, which can be used to implement the CMDBs described herein. The computer environment 7000 is only one example of a computing environment and is not intended to suggest any limitation as to the scope of use or functionality of the computer and network architectures. Neither should the computer environment 7000 be interpreted as having any dependency or requirement relating to any one or combination of components illustrated in the example computer environment 7000.

Computer environment 7000 includes a general-purpose computing device in the form of a computer 7002. The components of computer 7002 can include, but are not limited to, one or more processors or processing units 7004, system memory 7006, and system bus 7008 that couples various system components including processor 7004 to system memory 7006.

System bus 7008 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 7002 may include a variety of computer readable media. Such media can be any available media that is accessible by computer 7002 and includes both volatile and non-volatile media, removable and non-removable media.

System memory 7006 includes computer readable media in the form of volatile memory, such as random access memory (RAM) 7010; and/or non-volatile memory, such as read only memory (ROM) 7012 or flash RAM. Basic input/output system (BIOS) 7014, containing the basic routines that help to transfer information between elements within computer 7002, such as during start-up, is stored in ROM 7012 or flash RAM. RAM 7010 typically contains data and/or program modules that are immediately accessible to and/or presently operated on by processing unit 7004.

Computer 7002 may also include other removable/non-removable, volatile/non-volatile computer storage media. By way of example, FIG. 7 illustrates hard disk drive 7016 for reading from and writing to a non-removable, non-volatile magnetic media (not shown), magnetic disk drive 7018 for reading from and writing to removable, non-volatile magnetic disk 7020 (e.g., a “floppy disk”), and optical disk drive 7022 for reading from and/or writing to a removable, non-volatile optical disk 7024 such as a CD-ROM, DVD-ROM, or other optical media. Hard disk drive 7016, magnetic disk drive 7018, and optical disk drive 7022 are each connected to system bus 7008 by one or more data media interfaces 7025. Alternatively, hard disk drive 7016, magnetic disk drive 7018, and optical disk drive 7022 can be connected to the system bus 7008 by one or more interfaces (not shown).

The disk drives and their associated computer-readable media provide non-volatile storage of computer readable instructions, data structures, program modules, and other data for computer 7002. Although the example illustrates a hard disk 7016, removable magnetic disk 7020, and removable optical disk 7024, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 7016, magnetic disk 7020, optical disk 7024, ROM 7012, and/or RAM 7010, including by way of example, operating system 7026, one or more application programs 7028, other program modules 7030, and program data 7032. Each of such operating system 7026, one or more application programs 7028, other program modules 7030, and program data 7032 (or some combination thereof) may implement all or part of the resident components that support the distributed file system.

A user can enter commands and information into computer 7002 via input devices such as keyboard 7034 and a pointing device 7036 (e.g., a “mouse”). Other input devices 7038 (not shown specifically) may include a microphone, joystick, game pad, satellite dish, serial port, scanner, and/or the like. These and other input devices are connected to processing unit 7004 via input/output interfaces 7040 that are coupled to system bus 7008, but may be connected by other interface and bus structures, such as a parallel port, game port, or a universal serial bus (USB).

Monitor 7042 or other type of display device can also be connected to the system bus 7008 via an interface, such as video adapter 7044. In addition to monitor 7042, other output peripheral devices can include components such as speakers (not shown) and printer 7046, which can be connected to computer 7002 via I/O interfaces 7040.

Computer 7002 can operate in a networked environment using logical connections to one or more remote computers, such as remote computing device 7048. By way of example, remote computing device 7048 can be a PC, portable computer, a server, a router, a network computer, a peer device or other common network node, and the like. Remote computing device 7048 is illustrated as a portable computer that can include many or all of the elements and features described herein relative to computer 7002. Alternatively, computer 7002 can operate in a non-networked environment as well.

Logical connections between computer 7002 and remote computer 7048 are depicted as a local area network (LAN) 7050 and a general wide area network (WAN) 7052. Such networking environments are commonplace in offices, enterprise-wide computer networks, intranets, and the Internet.

When implemented in a LAN networking environment, computer 7002 is connected to local network 7050 via network interface or adapter 7054. When implemented in a WAN networking environment, computer 7002 typically includes modem 7056 or other means for establishing communications over wide network 7052. Modem 7056, which can be internal or external to computer 7002, can be connected to system bus 7008 via I/O interfaces 7040 or other appropriate mechanisms. It is to be appreciated that the illustrated network connections are examples and that other means of establishing at least one communication link between computers 7002 and 7048 can be employed.

In a networked environment, such as that illustrated with computing environment 7000, program modules depicted relative to computer 7002, or portions thereof, may be stored in a remote memory storage device. By way of example, remote application programs 7058 reside on a memory device of remote computer 7048. For purposes of illustration, applications or programs and other executable program components such as the operating system are illustrated herein as discrete blocks, although it is recognized that such programs and components reside at various times in different storage components of computing device 7002, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A configuration management database (CMDB) system, comprising:
a datastore comprising:
a first data structure to store information identifying a plurality of configuration items, and
a second data structure separate from the first data structure to store information identifying configuration item attributes of the plurality of configuration items.

2. The system of claim 1, wherein the datastore further comprises a third data structure separate form the first data structure to store information regarding relationships between configuration items.

3. The system of claim 1, further comprising an access unit to enable a user to access to information stored in the datastore.

4. The system of claim 3, wherein the access unit comprises an automated inventory component.

5. The system of claim 1, wherein the datastore further comprises a fourth data structure to store information defining configuration item attributes stored in the second data structure.

6. The system of claim 5, wherein the datastore further comprises a fifth data structure to store information describing a plurality of types of attributes stored in the fourth data structure.

7. The system of claim 1, wherein the datastore further comprises a sixth data structure to store information describing a plurality of types of configuration items.

8. The system of claim 1, wherein the datastore further comprises a seventh data structure to store information related to requests for changes to the system.

9. The system of claim 8, wherein the datastore further comprises an eighth data structure to store a list of default approvers for requests for changes to the system.

10. The system of claim 8, wherein the datastore further comprises a ninth data structure to store relationships between requests for changes to the system.

11. A computer readable medium having a data structure for use in a configuration management database (CMDB) system, the data structure comprising:
a first data structure component to store information identifying a plurality of configuration items, and
a second data structure component separate from the first data structure component to store information identifying configuration item attributes of the plurality of configuration items.

12. The computer readable medium of claim 11, wherein the data structure further comprises a third data structure component separate form the first data structure component to store information regarding relationships between configuration items.

13. The computer readable medium of claim 11, wherein the data structure further comprises a fourth data structure component to store information defining configuration item attributes stored in the second data structure component.

14. The computer readable medium of claim 13, wherein the data structure further comprises a fifth data structure component to store information describing a plurality of types of attributes stored in the fourth data structure component.

15. The computer readable medium of claim 11, wherein the data structure further comprises a sixth data structure component to store information describing a plurality of types of configuration items.

16. The computer readable medium of claim 11, wherein the data structure further comprises a seventh data structure component to store information related to requests for changes to the CMDB.

17. The computer readable medium of claim 16, wherein the data structure further comprises an eighth data structure component to store a list of default approvers for requests for changes to the CMDB.

18. The computer readable medium of claim 16, wherein the data structure further comprises a ninth data structure component to store relationships between requests for changes to the CMDB.

19. The computer readable medium of claim 11, wherein the data structure further comprises a tenth data structure component to store information defining groups of persons having a common authority to perform a function related to the CMDB.

20. The computer readable medium of claim 19, wherein the data structure further comprises an eleventh data structure component to store information identifying members of the groups defined in the tenth data structure component.

21. A schema for use in implementing a configuration management database, the schema comprising:
a first entity to store information identifying a plurality of configuration items, and
a second entity separate from the first entity to store information identifying configuration item attributes of the plurality of configuration items.

22. The schema of claim 21, wherein the schema further comprises a third entity separate form the first entity to store information regarding relationships between configuration items.

23. The schema of claim 21, wherein the data structure further comprises a fourth entity to store information defining configuration item attributes stored in the second entity.

24. The schema of claim 23, wherein the data structure further comprises a fifth entity to store information describing a plurality of types of attributes stored in the fourth entity.

25. The schema of claim 21, wherein the data structure further comprises a sixth entity to store information describing a plurality of types of configuration items.

26. The schema of claim 21, wherein the data structure further comprises a seventh entity to store information related to requests for changes to the CMDB.

27. The schema of claim 26, wherein the data structure further comprises an eighth entity to store a list of default approvers for requests for changes to the CMDB.

28. The schema of claim 26, wherein the data structure further comprises a ninth entity to store relationships between requests for changes to the CMDB.

29. The schema of claim 21, wherein the data structure further comprises a tenth entity to store information defining groups of persons having a common authority to perform a function related to the CMDB.

30. The schema of claim 29, wherein the data structure further comprises an eleventh entity to store information identifying members of the groups defined in the tenth entity.

31. A method for use in implementing a configuration item management database (CMDB), the method comprising:
defining a plurality of configuration items each having one or more attributes;
storing information identifying the defined configuration items in a first data structure; and
storing information identifying the defined attributes of the configuration items in a second data structure separate from the first data structure.

32. The method of claim 31 further comprising identifying relationships between configuration items of the plurality of configuration items and storing information regarding the identified relationships in a third data structure that is separate from the first data structure.

33. The method of claim 31, further comprising defining a fourth data structure, that is separate from the first data structure, to store requests for changes to configuration items of the CMDB.

34. The method of claim 32, further comprising defining a fifth data structure to store relationships between stored in the fourth data structure.

35. A method for use in implementing a configuration item management database (CMDB), the method comprising:
defining a first data structure to store a request for a change (RFC) to configuration item; and
defining a second data structure separate from the first data structure to store information regarding a relationship between RFCs stored in the first data structure.

36. The method of claim 35 further comprising storing information identifying an approver for an RFC in a third data structure separate from the first and second data structures.

37. The method of claim 36 further comprising storing information identifying another approver for an RFC in a fourth data structure separate from the first, second and third data structures, wherein the third and fourth data structures store information regarding default and optional approvers, respectively.
